(19) United States
(12) Patent Application Publication
(10) Pub. No.: US 2003/0118757 A1
(43) Pub. Date: Jun. 26, 2003

(54) Process for producing hollow bodies comprising fibre-reinforced ceramic materials

(76) Inventors: Moritz Bauer, Augsburg (DE); Michael Heine, Allmannshofen (DE); Udo Gruber, Neusaess (DE); Ronald Huener, Baar (DE); Andreas Kienzle, Thierhaupten (DE); Andreas Rahn, Wertingen (DE); Rainer Zimmermann-Chopin, Ellgau (DE)

Correspondence Address: ProPat, L.L.C., 2912 Crosby Road, Charlotte, NC, 28211-2815, US

(21) Appl. No.: 10/256,491

(22) Filed: Sep. 26, 2002

(30) Foreign Application Priority Data
Oct. 2, 2001 (DE) 101 48 658.8

(51) Int. Cl. C01B 31/02; B29C 33/76

(52) U.S. Cl. 428/34.1; 264/29.7; 264/317

(57) ABSTRACT

Process for producing hollow bodies comprising fibre-reinforced ceramic materials, where cores whose shape corresponds to that of the hollow spaces are produced in a first step, a green body is produced in a second step by introducing the abovementioned cores and a press moulding compound into a mould, where the press moulding compound comprises carbon fibres and/or carbon threads and pitch and/or resins, the green body is cured in a third step by heating under pressure, the cured green body is carbonised in a fourth step by heating in the absence of oxidants to form a C/C body, and, if desired, the C/C body is infiltrated with liquid metal with retention of its shape in a fifth step, with at least partial formation of carbides occurring, where the cores comprise a material which in the fourth step melts without decomposition at a temperature above the curing temperature of the shaping by pressing of the press moulding compound; hollow bodies produced by this process and also their use as brake disks, clutch disks and friction disks

### FIELD OF THE INVENTION

The present invention relates to a process for producing hollow bodies comprising fibre-reinforced ceramic materials.

### BACKGROUND OF THE INVENTION

In particular, the invention relates to a process for producing a porous fibre-reinforced carbon-containing shaped body which has recesses or hollow spaces and is close to the final shape, in particular a fibre-reinforced C/C body (“CFC” or “CFRC”=carbon fibre reinforced carbon) which is shaped from binder-containing fibre compositions by means of a pressing procedure using pressing cores and is converted into C/C in a subsequent thermal treatment, and also, if appropriate, the densification of a porous fibre-reinforced carbon-containing shaped body to form a ceramic matrix, in particular by infiltration of the C/C body with liquid metal, if appropriate with subsequent heat treatment, so that the matrix then comprises metals and the metal carbides formed by reaction with the carbon, possibly together with residual unreacted carbon.

### SUMMARY OF THE INVENTION

The process of the invention relates particularly to the production of ceramic composite materials which are reinforced with carbon fibres and have recesses and hollow spaces and which are converted by infiltration with silicon melts so as to react with at least part of the carbon to form silicon carbide (SiC) into composite materials which are reinforced with carbon fibres and have an SiC-containing or carbon- and SiC-containing matrix (C/SiC or C/C—SiC materials). These composite materials are employed, in particular, in brake disks, clutch disks and friction disks and also as construction materials which are resistant to high temperatures.

### DETAILED DESCRIPTION OF THE PREFERRED EMBODIMENTS

Materials used for automotive brake disks are nowadays predominantly steel or gray cast iron, and in aircraft applications carbon materials reinforced with carbon fibres (C/C). The properties required of the disk materials are high mechanical stability, heat resistance, hardness and wear resistance in combination with the friction partner in the friction pairing of the brake. The use temperature of gray cast iron brake disks used hitherto is limited by the melting point of the material. The temperature at which mechanical failure occurs is, depending on the stress, significantly below the melting point. Furthermore, there is a risk of cracking of the disks due to transformation of the metallic microstructure upon heating. The use of fibre-reinforced ceramics as a material for brake disk applications has been found to be a solution to these problems. Materials based on silicon carbide reinforced with carbon fibres (C/SiC) in particular have been found to be useful for this application. The advantages of this material are the lower density (thus reduced weight for a given volume), the high hardness and heat resistance up to about 1400° C. and, not least, the extremely high wear resistance. The significantly reduced weight of brake disks made of these C/SiC materials is a positive factor in improving comfort and safety by reduction of the unsprung masses in motor vehicles and an economic factor in the aircraft field. The high hardness and wear resistance of C/SiC components makes it possible to achieve far longer operating lives compared to previously customary materials based on C/C or metal.

A process for producing C/SiC components is known from, for example, DE-A 197 10 105 and comprises, inter alia, the following steps:

preparation of a press moulding compound of carbon-containing fibres or fibre bundles which may be coated with a coating and fillers and/or binders such as resins and/or pitch,

shaping of the mixture under pressure and at elevated temperature and carbonisation of the carbon-containing fillers and binders to produce a shaped body, in particular a shaped body comprising carbon reinforced with carbon fibres (C/C) and, if appropriate, subsequent graphitisation,

infiltration of at least an outer layer of the shaped body with a silicon melt and at least partial reaction with the carbon in the shaped body to produce SiC, thus forming a shaped body which comprises, at least in the outer layer, a composite ceramic composed of carbon-containing fibres embedded in a matrix comprising predominantly SiC, Si and C (here referred to as C/SiC).

In the following, the term C/SiC also encompasses the material variant in which, as described above, only an outer layer of the carbon body is infiltrated with silicon and reacted therewith.

Customary production processes also include such where the C/C body is densified via the liquid or gas phase with carbon precursors, namely substances which form carbon upon heating in the absence of oxidising media, or by means of carbon, or the matrix comprising predominantly SiC, Si and C is produced by gas-phase infiltration (CVD, chemical vapor deposition, or CVI, chemical vapor infiltration) or by pyrolysis of Si-containing preceramic polymers.

Present-day metallic brake disks frequently have ventilation slits or channels through which air flows within the disk so as to reduce the temperature of the disk and decrease wear of the friction lining under high stress. Such ventilation channels are also employed in brake disks based on C/SiC, particularly to lower the temperature so as to spare the brake linings and further components of the system.

One process for producing friction units of C/C—SiC material having ventilation channels, hollow spaces and recesses in which a structured porous carbon body close to the final shape is infiltrated with liquid silicon is known from EP-B 0 788 468. This process makes use of the fact that the liquid silicon infiltration and formation of the Si- and SiC-rich composite matrix occurs virtually without changes to the geometry of the C/C intermediate body, so that the hollow spaces and recesses can be produced in the relatively soft and readily machinable C/C intermediate body and not only in the very hard C/C—SiC composite ceramic. It is supposed, inter alia, that the hollow spaces and recesses be formed by means of soluble cores comprising polystyrene foam, e.g. ®Styropor, or other rigid foams, by means of pyrolyzable cores comprising polyvinyl alcohol or by means of removable cores comprising rubber, metal or ceramic.

The polymers proposed there as core material are found to be too soft and thermally unstable for the press moulding with thermal curing of the press moulding compound employed. Treatment with solvents to remove the cores involves the risk of destroying the generally still very soft intermediate body. This risk is likewise present in the pyrolysis of the proposed polymer polyvinyl alcohol which on heating forms gaseous decomposition products within the preform; these gaseous products are given off copiously and can break the shaped body. Customary metals and ceramics are also unsuitable for the thermal processes for curing the pressed green body and its carbonisation to form the C/C intermediate body owing to their generally unmatched thermophysical properties.

In DE-C 198 24 571, a further process is proposed for producing hollow spaces in an object comprising C/SiC composite ceramics. The hollow spaces are formed during manufacture of the preform by pressing using cores of silicon, silicon alloys or Si/BN mixtures. The cores are not removed from the preform until the step of infiltration with liquid silicon, and serve as a source of silicon for the siliconisation step. Before siliconisation, the preform has to be heated and converted into a C/C intermediate body, with the organic constituents, for example binders, being decomposed and shrinkage of the preform occurring. This shrinkage leads to the preform shrinking onto the silicon-containing cores which in turn additionally undergo a thermal expansion due to heating. In general, undesirable stress is generated, and even fracture occurs in the preform as a result, both of which have to be avoided.

It is therefore an object of the invention to provide a core material and to develop a process matched thereto which is suitable for shaping of fibre-reinforced carbon-containing intermediate bodies by pressing so that they have a shape close to the final shape, with the core being able to be removed gently, simply and preferably without leaving a residue and without damaging the cured intermediate body.

According to the invention, this object is achieved by using cores made of materials which, during the shaping by pressing, melt without decomposition above the curing temperature and are, if appropriate, pyrolysed without leaving a residue in the further thermal process. The intermediate bodies which have been freed of the core can then, if appropriate, be passed to infiltration with molten metal, in particular siliconisation, to give the finished composite ceramic.

The invention accordingly provides a process for producing hollow bodies comprising fibre-reinforced ceramic materials, where

cores whose shape corresponds to that of the hollow spaces are produced in a first step,

a green body is produced in a second step by introducing the abovementioned cores and a press moulding compound into a mould, where the press moulding compound comprises carbon fibres and/or carbon fibre bundles and/or carbon threads, which have preferably been coated with carbon or carbon-containing compounds, and pitch and/or resins which form carbon-containing residues on heat treatment in a non-oxidising atmosphere, in such a way that the position of the cores corresponds to the desired position of the hollow spaces to be formed,

the green body is cured by heating to a temperature of from 120° C. to 280° C. under pressure in a third step,

the cured green body, also referred to as intermediate body, is carbonised in a fourth step by heating in a non-oxidising atmosphere to a temperature of from about 750° C. to about 1100° C. to give a C/C body, and, if desired,

the C/C body is infiltrated with liquid metal with retention of its shape in a fifth step, with at least partial reaction of the carbon present in the matrix of the C/C body with the metal to form carbides,

wherein the cores comprise predominantly a material which in the fourth step melts without decomposition at a temperature above the curing temperature of the shaping by pressing of the press moulding compound.

Silicon is also encompassed by the term “metals”, for the purposes of this invention.

The linear coefficient of thermal expansion of the material used for the cores up to its decomposition temperature is preferably not more than 1·10⁻⁵ K⁻¹.

In this context, “predominantly” means at least 50% of the mass.

Preference is given to using materials whose melting point is not more than 100° C., particularly preferably not more than 50° C. and in particular not more than 30° C., above the curing temperature of the green body.

In a further preferred embodiment, the materials capable of melting without decomposition which are used for the cores are pyrolysed without leaving a substantial residue (i.e. not more than 20%, preferably not more than 10% of the original mass) at a temperature above their melting point, preferably at least 10° C., in particular at least 50° C., above their melting point.

If thermoplastic polymers are used as core materials, the cores are preferably produced by injection moulding. In general, suitable shaping processes are the known methods such as cold or hot pressing, casting, pressure casting or cutting machining, depending on the material used.

The process of the present invention provides for press moulding compounds comprising carbon fibres, thermally curable binders and, in particular, carbon-containing additives to be pressed in the second step to form green bodies having hollow spaces and/or recesses.

The carbon fibre layers of the C/C intermediate body are preferably built up in the vicinity of the core in a predetermined preferential direction of the carbon reinforcing fibres on the core. For this purpose, preference is given to using press moulding compounds which comprise carbon fibres having a mean length of at least 5 mm. The press moulding compound of the second step is then preferably introduced into the mould in such a way that the carbon fibres are predominantly oriented parallel to the direction of the highest tensile stress in the resulting shaped part. In this context, predominantly means at least 50%. It is also possible to wind tapes made of parallel and bound carbon fibres (also known as “UDTs”=unidirectional tapes) around the cores, and to fix this sheath by means of thermally curable binders if necessary. Further press moulding compounds containing short fibres or fibre bundles are then usually applied on top of this layer of carbon fibres or threads oriented in the preferred direction.

In another preferred embodiment, carbon fibres are used in the form of coated short fibre bundles. Particular preference is here given to fibres or fibre bundles which are coated with graphitised carbon and have mean lengths of less than 5 mm.

As thermally curable binders, use is made of pitches such as coal tar pitch or petroleum pitch and/or preferably curable resins such as phenolic resins, epoxy resins, polyimides, filler-containing mixtures with furfuryl alcohol or furan resins. These compositions are, for this purpose, introduced into a pressing mould which is provided with “lost cores”. The cores occupy the space of the hollow spaces or recesses to be formed later in the composite ceramic. After the pressing mould has been filled, the composition is pressed and cured under the action of heat.

In one embodiment of the invention, the cores are produced from meltable materials which are selected from the group consisting of thermoplastic polymers (synthetic polymers) which can be pyrolysed without leaving a residue, hereinafter also referred to as thermoplastic cores. According to the invention, the thermoplastic material for the core is selected so that its melting point is above the curing temperature in the shaping process for the green body, typically in the range from 120 to 300° C., but significantly below the carbonisation temperature of the pressed and cured green bodies. The melting point is usually at least 150° C., preferably at least 180° C. and particularly preferably in the range from 220° C. to 280° C. If phenolic resins are used as binders for the press moulding compounds, the melting point of the thermoplastic is, for example, preferably above 150° C. For the preferred shaping by pressing and hot curing of the binders, the thermoplastic core has to meet strict requirements in terms of its heat distortion resistance. The heat distortion temperature (as defined in ISO 75 A) is usually above 80° C., preferably at least 150° C. The hardness (Brinell hardness) should be at least 30 MPa.

Particularly useful thermoplastics are polyamides (PAs) such as PA 66, polyimides (PIs) such as polyether imide (®Ultem, General Electric) or modified polymethacrylimide (PMI, e.g. ®Kamax, Rohm & Haas), polyoxymethylene (POM) and polyterephthalates (PETP), and also their copolymers. After shaping by pressing, the green body together with the thermoplastic core is converted into the C/C state, i.e. carbonised. This is generally achieved by heating in a non-oxidising atmosphere, e.g. under protective gas (nitrogen) or under reduced pressure to temperatures in the range from about 750° C. to 1100° C. If the bodies are heated to temperatures above about 1800° C., graphitisation of the carbon additionally takes place. It is important that the thermoplastic core melts and at least some of the melt flows out of the hollow spaces of the green body without decomposing to form gaseous products. The coefficient of thermal expansion of the core is preferably not more than 1·10⁻⁵ K⁻¹, to make sure that the green body is not subjected to stresses during heating to the melting point of the thermoplastic core.

The thermoplastic polymer can be collected after melting and be reused if appropriate. However, it is particularly preferred that the thermoplastic is pyrolysed during the carbonisation step, especially because the porous green body can retain residues of the melt in the pores. The pyrolysis then takes place at higher temperatures, essentially only outside the green body. This avoids rupture of the green body. The pyrolysis, i.e. the decomposition to form gaseous products, usually occurs at above 250° C., preferably at least 10° C. above the melting point of the thermoplastic material. It is advantageous to use thermoplastics which can be pyrolysed virtually completely, although small amounts of residual carbon do not interfere since they are incorporated into the ceramic matrix to be formed later. The residue remaining on pyrolysis of suitable polymers at 900° C. is not more than 10%, particularly preferably not more than 8% and very particularly preferably not more than 1%. Polymers which are well suited for this purpose are those based on PA, PMI, POM and PETP. Preference is given to polyamide 66, polyoxymethylene, polyethylene terephthalate and polymethacrylimide, and also their derivatives, copolymers and blends. As components of polymer blends, it is also possible, in particular, to use polymers which are thermally less stable.

In a further embodiment of the invention, use is made of thermoplastic cores which are manufactured from filler-containing thermoplastic materials to improve their strength and shape stability. The fillers may be in the form of powders, fibres, microspheres or whiskers and are selected from the group consisting of glass, mineral fillers such as chalk, wollastonite, ceramic materials and metals. Preference is given to using fillers which neither decompose nor melt up to the carbonisation temperature. The fillers can be recaptured as pyrolysis residue after carbonisation and can then be removed and possibly reused. Preference is given to using fibrous fillers such as glass, mineral or carbon fibres. The mass fraction of fillers in the filled thermoplastic is, depending on the method of manufacturing the cores, at least 15%, preferably at least 30%. It is also possible to use organic, non-pyrolysable materials as fillers; carbonisable resins such as the binders mentioned above are particularly useful.

It is likewise possible to use filler-containing thermoplastic materials where the fillers comprise oxidation agents (oxidants) which act as pyrolysis accelerators. To simplify the removal of any residues of the thermoplastic core from the green body, this incorporation of oxidants has been found to be very useful. These oxidants contribute to the targeted oxidative decomposition of the thermoplastic core. Particular preference is given to incorporation of ammonium nitrate, for example in a mass fraction of at least 10%.

The amount of pyrolysis gases liberated during the decomposition of the core can be reduced and the carbonisation step for the green bodies can be technologically simplified at the same time when, in a further advantageous embodiment of the invention, foamed thermoplastics are used as core material. In this case, it is possible to use, for example, foamed polyimide such as polymethacrylimide.

In a further embodiment of the invention, cores of low-melting metals are used. Process and requirements which the materials have to satisfy are virtually identical to those in the case of thermoplastic cores up to the melting step. The advantage of metals over thermoplastics is their significantly higher strength, but there is not a possibility of pyrolysis as in the case of the thermoplastic cores. It is therefore advantageous to collect and reuse the molten metals. Particularly useful metals are low-melting metal alloys having melting points below 300° C. Alloys based on the metals Al, Zn, Cu, Bi, Pb, Sn, Fe, Sb and Si are usually used. In the case of metal alloys, bismuth and bismuth alloys have been found to be very useful since they melt at a low temperature and have a negative coefficient of thermal expansion. This avoids rupture of the green body on heating. After they have melted and flown out, the molten metals can be returned to the production process. Apart from this economic and ecological advantage, the greatest advantage of the use of a metallic core is the fact that it can be produced very easily in a casting mould. Particular preference is given to Bi and Sn alloys, and also Zn/Mg/Al/Cu alloys.

After carbonisation of the green body, any pyrolysis residues or carbon residues present in the hollow spaces formed are removed and a porous C/C body having hollow spaces or recesses is obtained and can be utilised further. It can be subjected to further machining/shaping or assembled or adhesively bonded to produce more complex structures.

In a fifth step, the porous C/C body is, if desired, densified to obtain a more usable workpiece.

In a preferred embodiment of the process of the invention, this densification is effected by converting the carbon of the C/C body at least partly into the corresponding carbides by infiltration with molten metals and, if appropriate, subsequent heat treatment. Preference is given to infiltration with molten silicon, in which case at least part of the carbon (preferably the carbon in the matrix) reacts to form silicon carbide; the matrix then comprises SiC, unreacted carbon and unreacted silicon. For this purpose, the C/C body is covered with silicon powder and then heated under reduced pressure to temperatures of from about 1500 to about 1800° C. Depending on the intended use, it is not absolutely necessary to convert all of the C/C body to C/SiC, but it is usual for at least the outer layer to be converted to C/SiC. Although silicon melt infiltration is the preferred process, the C/C body can also be densified by means of other customary processes to form the matrices customary in composite materials technology. In particular, the liquid silicon infiltration process can also be carried out using silicon alloys which may further comprise, inter alia, metals such as Cr, Fe, Co, Ni, Ti and/or Mo.

The process described is preferably used for producing brake disks or clutch disks. Here, the press moulding compound and the cores are introduced into a cylindrical mould, with continuous layers of the press moulding compound preferably being introduced as lowermost and uppermost layers. The thickness of the bottom layer and the covering layer after pressing is preferably at least 7 mm. These layers form the friction layer of the brake or clutch disk. The shaped body which forms the brake or clutch disk usually has the outer shape of an annulus, i.e. the region near the axis is open over the entire thickness of the disk. The cores are preferably arranged in a rotation-symmetric manner about the axis of the cylinder, and preference is given to using at least 2 and not more than 16 cores. The shape of the cores is preferably such that the hollow spaces formed extend from the periphery of the cylindrical shaped body to the internal edge of the shaped body and thus form an open passage between the internal and external cylindrical edges of the annulus.

1. A process for producing hollow bodies comprising fibre-reinforced ceramic materials, where
cores whose shape corresponds to that of the hollow spaces are produced in a first step,
a green body is produced in a second step by introducing the abovementioned cores and a press moulding compound into a mould, where the press moulding compound comprises carbon fibres and/or carbon threads and pitch and/or resins which form carbon-containing residues on heat treatment in a non-oxidising atmosphere, in such a way that the position of the cores corresponds to the desired position of the hollow spaces to be formed,
the green body is cured by heating to a temperature of from 120° C. to 280° C. under pressure in a third step,
the cured green body is carbonised in a fourth step by heating in a non-oxidising atmosphere to a temperature of from about 750° C. to about 1100° C. to give a C/C body,
wherein the cores comprise a material which in the fourth step melts without decomposition at a temperature above the curing temperature of the shaping by pressing of the press moulding compound.

2. The process as claimed in claim 1, wherein, subsequent to the fourth step,
the C/C body is infiltrated with liquid metal with retention of its shape in a fifth step, with at least partial reaction of the carbon present in the matrix of the C/C body with the metal to form carbides.

3. The process as claimed in claim 1, wherein the meltable materials used for the cores are pyrolysed without leaving a substantial residue at a temperature above their melting point.

4. The process as claimed in claim 3, wherein the residue remaining after pyrolysis of the meltable material for the core is not more than 10%.

5. The process as claimed in claim 1, wherein the press moulding compound of the second step comprises carbon fibres having a mean length of at least 5 mm as reinforcing material.

6. The process as claimed in claim 1, wherein the press moulding compound of the second step is introduced into the mould in such a way that the carbon fibres are predominantly oriented parallel to the direction of the highest tensile stress in the resulting shaped part.

7. The process as claimed in claim 1, wherein the press moulding compound of the second step comprises carbon fibres in the form of coated short fibre bundles as reinforcing material.

8. The process as claimed in claim 1, wherein the material of the press moulding compounds comprises pitches selected from among coal tar pitch and petroleum pitch and/or curable resins selected from the group consisting of phenolic resins, epoxy resins, polyimides, filler-containing mixtures with furfuryl alcohol and furan resins.

9. The process as claimed in claim 1, wherein the material of the cores has a linear coefficient of thermal expansion up to its decomposition temperature of not more than 1·10⁻⁵ K⁻¹.

10. The process as claimed in claim 1, wherein the material for the core is a thermoplastic polymer having a heat distortion temperature according to ISO 75A of at least 80° C. and a Brinell hardness of at least 30 MPa.

11. The process as claimed in claim 1, wherein the material for the core is a filler-containing thermoplastic polymer in which the mass fraction of fillers is at least 15%.

12. The process as claimed in claim 11, wherein the fillers are selected from the group consisting of chalk, glass spheres, glass microspheres, wollastonite, glass fibres, carbon fibres and ceramic fibres.

13. The process as claimed in claim 11, wherein the material used for the core is a filler-containing thermoplastic polymer whose fillers comprise oxidants acting as pyrolysis accelerators.

14. The process as claimed in claim 1, wherein the material used for the core is a foamed thermoplastic.

15. The process as claimed in claim 1, wherein the material used for the core is a low-melting metal.

16. The process as claimed in claim 15, wherein low-melting metal alloys having melting points below 300° C. are used.

17. The process as claimed in claim 15, wherein alloys based on the metals Al, Zn, Cu, Bi, Pb, Sn, Fe, Sb and Si are used.

18. The process as claimed in claim 15, wherein the metals are selected from among bismuth and bismuth alloys, tin alloys and Zn/Mg/Al/Cu alloys.

19. A hollow body produced by the process of claim 1.

20. A hollow body produced by the process of claim 2.

21. A hollow body produced by the process of claim 1 and configured as a brake or clutch disk.

22. A hollow body produced by the process of claim 2 and configured as a brake or clutch disk.
